(19) United States
(12) Patent Application Publication
(10) Pub. No.: US 2021/0096239 A1
(43) Pub. Date: Apr. 1, 2021

(54) INTRUSION DETECTION SYSTEM AND INTRUSION DETECTION METHOD

(71) Applicant: Panasonic Corporation, Osaka (JP)

(72) Inventors: Makoto YASUGI, TOKYO (JP); Yoji YOKOYAMA, KANAGAWA (JP)

(73) Assignee: Panasonic Corporation, Osaka (JP)

(21) Appl. No.: 17/044,124

(22) PCT Filed: Mar. 29, 2019
(86) PCT No.: PCT/JP2019/013978

§ 371 Date: Sep. 30, 2020

(30) Foreign Application Priority Data
Apr. 2, 2018 (JP) 2018-070954

(51) Int. Cl. G01S 13/86; G01S 13/931; G01S 13/04

(52) U.S. Cl. CPC G01S 13/867; G01S 13/04; G01S 13/931

(57) ABSTRACT

Provided are an intrusion detection system and an intrusion detection method. The intrusion detection system includes: a camera which photographs a surveillance area and generates image data; a millimeter-wave radar which scans a scanning area contained within the surveillance area and generates millimeter-wave data; and an information processing server which is connected to the camera and the millimeter-wave radar, and acquires image data and millimeter-wave data. The information processing server is equipped with: a data synchronization unit which synchronizes the image data and millimeter-wave data; a determination unit which determines whether an object has intruded into a detection area contained within the scanning area, on the basis of millimeter-wave data; and a screen generation unit which associates the synchronized image data and millimeter-wave data and generates a surveillance screen which indicates the determination results generated by the determination unit.

### TECHNICAL FIELD

The present disclosure relates to an intrusion detection system and an intrusion detection method.

### BACKGROUND ART

Conventionally, the introduction of an intrusion detection system, which detects an intrusion of a person or the like into an intrusion prohibited area by using a monitoring camera, to a place such as an expressway or a platform of a station has been studied from the viewpoint of security.

For example, Patent Literature (hereinafter, referred to as “PTL”) 1 discloses a method in which a capturing device (monitoring camera) captures a road such as an expressway, a subject appearing on a captured image is detected and, in a case where an intrusion of the detected subject into a predetermined area corresponds to any of a plurality of intrusion patterns set in advance, it is detected that the subject has intruded into the predetermined area.

### CITATION LIST

### Patent Literature

PTL 1

Japanese Patent No. 6185779

### SUMMARY OF INVENTION

### Technical Problem

However, in a case where an intrusion is detected by using an image captured by a monitoring camera, sufficient detection accuracy may not be secured since the accuracy of intrusion detection is easily affected by a distance to a person to be detected, a change in sunshine at a place where an intrusion is detected, weather, or the like.

One non-limiting and exemplary embodiment of the present disclosure facilitates providing an intrusion detection system and an intrusion detection method, in which two sensor devices, that is, a camera and a radar, are combined and whereby an intrusion is accurately detected.

An intrusion detection system according to an exemplary embodiment of the present disclosure includes: a camera that captures a monitoring area, and generates image data; a millimeter-wave radar that scans a scanning area included in the monitoring area, and generates millimeter-wave data; and an information processing server that is connected to the camera and the millimeter-wave radar, and acquires the image data and the millimeter-wave data, wherein the information processing server includes: a data synchronizer that synchronizes the image data and the millimeter-wave data such that a difference between a timing at which the image data is generated and a timing at which the millimeter-wave data is generated is equal to or smaller than a certain value; a determiner that determines based on the millimeter-wave data whether or not there is an object intruding into a detection area included in the scanning area; and a screen generator that associates the image data and the millimeter-wave data which have been synchronized, with each other, and generates a monitoring screen that indicates a determination result by the determiner.

An intrusion detection method according to an exemplary embodiment of the present disclosure includes: acquiring image data from a camera, the image data being generated by capturing a monitoring area; acquiring millimeter-wave data from a millimeter-wave radar, the millimeter-wave data being generated by scanning a scanning area included in the monitoring area; synchronizing the image data and the millimeter-wave data such that a difference between a timing at which the image data is generated and a timing at which the millimeter-wave data is generated is equal to or smaller than a certain value; determining based on the millimeter-wave data whether or not there is an object intruding into a detection area included in the scanning area; and associating the image data and the millimeter-wave data which have been synchronized, with each other, and generating a monitoring screen that indicates a determination result.

It should be noted that general or specific embodiments may be implemented as a system, an integrated circuit, a computer program or a storage medium, or may be implemented as any combination of a system, an apparatus, a method, an integrated circuit, a computer program, and a storage medium.

An exemplary embodiment of the present disclosure facilitates providing an intrusion detection system and an intrusion detection method, in which two sensor devices, that is, a camera and a radar, are combined and whereby an intrusion is accurately detected.

Additional benefits and advantages of the disclosed exemplary embodiment will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a configuration of an intrusion detection system according to an embodiment of the present disclosure;

FIG. 2 illustrates an example of a configuration of an information processing server according to the embodiment of the present disclosure;

FIG. 3 is a flowchart illustrating an example of processing of the information processing server according to the embodiment of the present disclosure;

FIG. 4 illustrates an example of a display screen in a setting mode in the embodiment of the present disclosure;

FIG. 5 illustrates an example of screens displayed in each region illustrated in FIG. 4;

FIG. 6 illustrates an example of a display screen in an intrusion detection mode in the embodiment of the present disclosure;

FIG. 7 illustrates an example of screens displayed in each region illustrated in FIG. 6;

FIG. 8 illustrates an example of a display screen in a past intrusion detection information confirmation mode in the embodiment of the present disclosure; and

FIG. 9 illustrates an example of screens displayed in each region illustrated in FIG. 8.

### DESCRIPTION OF EMBODIMENTS

Hereinafter, an embodiment of the present disclosure will be described in detail with reference to the accompanying drawings as appropriate. However, more detailed description than necessary may be omitted. For example, detailed descriptions of already well-known matters and repeated descriptions for substantially the same configuration may be omitted. This is to prevent the following description from becoming unnecessarily redundant and to facilitate understanding by those skilled in the art.

Note that, the accompanying drawings and the following description are provided so that those skilled in the art understand the present embodiment sufficiently, and are not intended to limit the subject matters recited in the claims.

### Embodiment

<Configuration of Intrusion Detection System>

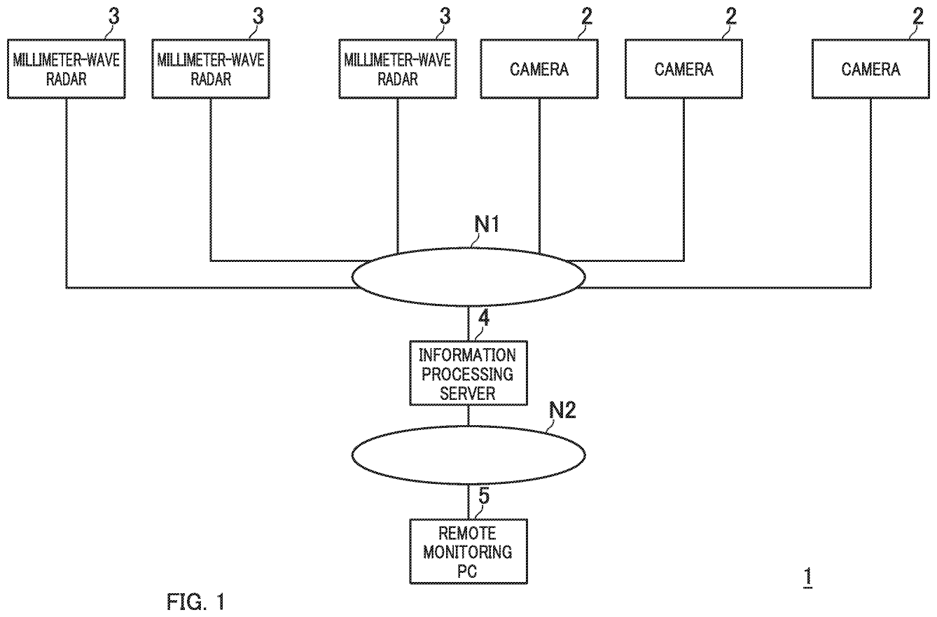

FIG. 1 illustrates an example of a configuration of intrusion detection system 1 according to the present embodiment. Intrusion detection system 1 includes a plurality of cameras 2, a plurality of millimeter-wave radars 3, information processing server (control apparatus) 4, and a remote monitoring personal computer (PC) 5. In the present embodiment, an intrusion detection system that detects an intrusion of a person into a predetermined area set on a road where vehicles, pedestrians, or the like pass will be described as an example.

Note that, a place where an intrusion is detected is not limited to a road, but may also be, for example, places such as a parking lot, a crossing of a railroad, a platform of a station, a public facility, a factory, a port, an airport, and a river bed. Further, an object whose intrusion is detected is not limited to a person, but may also be a vehicle, a ship, an airplane, an animal, and the like. Further, a point where an intrusion is detected may be described hereinafter as a monitoring point as appropriate.

Camera 2 and millimeter-wave radar 3 are connected to information processing server 4 through network N1. Network N1 may be a wireless network, a wired network, or a combination thereof.

Information processing server 4 is connected to remote monitoring PC 5 through network N2. Network N2 may be a wireless network, a wired network, or a combination thereof.

Camera 2 is provided, for example, above a structure (for example, a pole on which a road sign is installed) on a periphery of the road. Camera 2 captures an area around the periphery of the road, which includes the road. Note that, the area around the periphery of the road, which is in a capturing range of camera 2 and includes the road, may also be described as a monitoring area.

Camera 2 generates data of an image (image data) captured thereby, and transmits the captured image data to information processing server 4. The image data to be transmitted includes time information indicating a timing (for example, a time) at which the image data is generated. Note that, the time indicated by the time information may also be a time when camera 2 performs capturing. Further, for example, camera 2 may also transmit the image data in frame units to information processing server 4. Further, the image captured by camera 2 may also be described as a camera image. Further, for example, a coordinate system defining horizontal and vertical directions of the camera image may be described as a camera coordinate system. The camera coordinate system is defined, for example, based on a position where camera 2 is installed, an orientation of camera 2, and a viewing angle of the camera.

Millimeter-wave radar 3 is provided, for example, above a structure on a periphery of the road. Millimeter-wave radar 3 transmits a radar signal in the millimeter-wave band to the periphery of the road, and receives a reflected signal that is the radar signal reflected by an object around the periphery of the road. Note that, millimeter-wave radar 3 scans the periphery of the road by sequentially transmitting radar signals in a plurality of directions. An area in which millimeter-wave radar 3 scans radar signals may also be described as a scanning area.

Millimeter-wave radar 3 generates, for example, millimeter-wave data based on information on at least one of a time between a time when a radar signal is transmitted and a time when a reflected signal is received, a direction in which a radar signal is transmitted, a reception intensity of a reflected signal, and a Doppler frequency of a reflected signal.

Millimeter-wave data includes, for example, information indicating an object around the periphery of the road, which has reflected a radar signal (hereinafter, the object will be referred to as a reflection object). For example, millimeter-wave data is data including a set of points indicating a position of a reflection object (hereinafter, each of the points will be referred to as a reflection point) in a coordinate system defined by using a position of millimeter-wave radar 3 as a reference. The coordinate system defined by using a position of millimeter-wave radar 3 as a reference is, for example, a polar coordinate system in which each point on a plane is determined by a distance from a position of millimeter-wave radar 3 and an azimuth at which millimeter-wave radar 3 performs scanning. Note that, the coordinate system defined by using a position of millimeter-wave radar 3 as a reference may also be described as a millimeter-wave radar coordinate system. The millimeter-wave radar coordinate system is defined, for example, based on a position millimeter-wave radar 3, an orientation of millimeter-wave radar 3, and a scanning area (detection range) of millimeter-wave radar 3.

Note that the reflection point is not limited to one reflection point with respect to one reflection object. In millimeter-wave data, one reflection object may be represented by a plurality of reflection points.

Further, examples of the reflection object include vehicles and pedestrians (hereinafter, each referred to as a moving body) that travel around the periphery of the road, and structures provided around the periphery of the road (road signs, signals, or the like; hereinafter, each structure will be referred to as a stationary object). Millimeter-wave data may include a reflection point indicating a position of a moving body, and a reflection point indicating a position of a stationary object.

Millimeter-wave radar 3 transmits millimeter-wave data to information processing server 4. The millimeter-wave data to be transmitted includes time information indicating a timing (for example, a time) at which the millimeter-wave data is generated. Note that, the time indicated by the time information may also be a time when a radar signal for generating the millimeter-wave data is transmitted, or a time when a radar signal is received. Further, millimeter-wave radar 3 may scan a scanning area at a set period and transmit the millimeter-wave data to information processing server 4.

The timing at which camera 2 generates image data and the timing at which millimeter-wave radar 3 generates millimeter-wave data may not coincide, and may be different from each other. Further, the timing at which camera 2 transmits image data and the timing at which millimeter-wave radar 3 transmits millimeter-wave data may not coincide, and may be different from each other. For example, a frequency at which camera 2 generates image data is higher than a frequency at which millimeter-wave radar 3 generates millimeter-wave data.

Note that, camera 2 and millimeter-wave radar 3 may be installed in the same structure or in structures different from each other. Further, camera 2 and millimeter-wave radar 3 may be provided in the same housing or in separate housings.

Further, methods for installing camera 2 and millimeter-wave radar 3, places where camera 2 and millimeter-wave radar 3 are installed, and a relative positional relationship between camera 2 and millimeter-wave radar 3 are not limited. Further, a positional relationship between the monitoring area of camera 2 and the scanning area of millimeter-wave radar 3 is not limited. In the exemplary embodiment of the present disclosure, camera 2 and millimeter-wave radar 3 are preferably installed such that the scanning area of millimeter-wave radar 3 is included in the monitoring area of camera 2.

For example, at least one camera 2 and at least one millimeter-wave radar 3 are paired and provided at one monitoring point. Note that, at one monitoring point, two or more cameras 2 may be provided and/or two or more millimeter-wave radars 3 may be provided.

Information processing server 4 is connected to camera 2 and millimeter-wave radar 3, which are provided at each of a plurality of monitoring points, through network N1. Information processing server 4 acquires image data from camera 2, and acquires millimeter-wave data from millimeter-wave radar 3. Further, information processing server 4 generates a monitoring screen that indicates a result of intrusion detection at the monitoring points based on the image data and the millimeter-wave data. Information processing server 4 transmits data of the generated monitoring screen to remote monitoring PC 5 through network N2.

Note that, information processing server 4 may receive instruction information including a setting related to intrusion detection and/or an instruction related to a monitoring point, from remote monitoring PC 5. In this case, information processing server 4 generates a monitoring screen based on the instruction information.

Remote monitoring PC 5 receives the data of the monitoring screen from information processing server 4 through network N2. Remote monitoring PC 5 processes the data of the monitoring screen, and displays the monitoring screen on a display (not illustrated).

Note that, remote monitoring PC 5 may receive a setting related to intrusion detection and/or an instruction related to a monitoring point from a user through an operator (not illustrated), for example. In this case, remote monitoring PC 5 may transmit instruction information including the setting related to intrusion detection and/or an instruction related to a target monitoring point of the intrusion detection to information processing server 4.

Note that, although FIG. 1 illustrates one remote monitoring PC5, there may be a plurality of remote monitoring PCs 5. Further, although FIG. 1 illustrates networks N1 and N2, networks N1 and N2 may be the same network or different networks. Further, although an example has been described in which information processing server 4 is connected to camera 2 and millimeter-wave radar 3 through network N1, information processing server 4 may be connected to camera 2 and/or millimeter-wave radar 3 directly by a wired or wireless connection, not through network N1. Further, remote monitoring PC 5 may be connected to information processing server 4 directly by a wired or wireless connection, not through network N2.

In intrusion detection system 1 described above, in a case where a user who monitors intrusions inputs (or selects) a specific monitoring point through the operator of remote monitoring PC 5, for example, remote monitoring PC 5 transmits instruction information indicating the input (or selected) monitoring point to information processing server 4.

Information processing server 4 generates a monitoring screen related to road conditions at the monitoring point indicated by the instruction information. Information processing server 4 then transmits data of the generated monitoring screen to remote monitoring PC 5 that is the transmission source of the instruction information.

<Configuration of Information Processing Server>

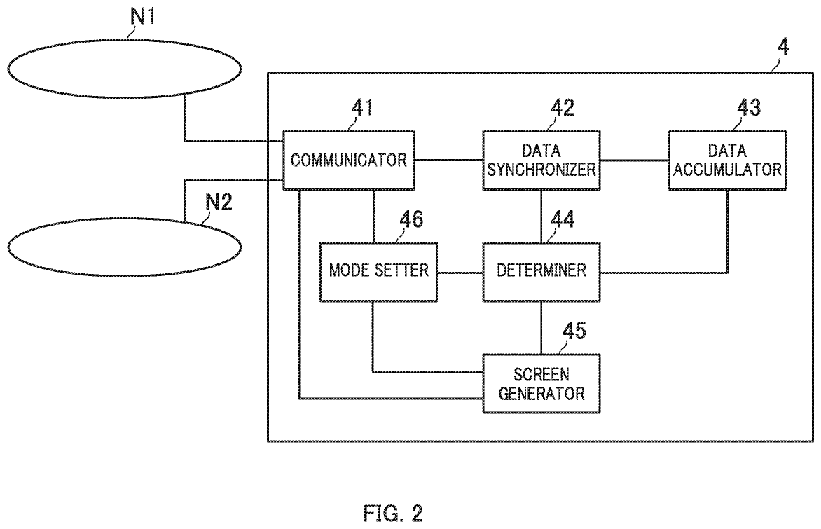

Next, an example of a configuration of information processing server 4 will be described. FIG. 2 illustrates an example of a configuration of information processing server 4 according to the present embodiment.

For example, information processing server 4 includes communicator 41, data synchronizer 42, data accumulator 43, determiner 44, screen generator 45, and mode setter 46.

Communicator 41 is an interface for communication with camera 2 and millimeter-wave radar 3 through network N1. Further, communicator 41 is an interface for communication with remote monitoring PC 5 through network N2.

Data synchronizer 42 acquires image data from camera 2 through communicator 41. Further, data synchronizer 42 acquires millimeter-wave data from millimeter-wave radar 3 through communicator 41.

Data synchronizer 42 synchronizes (or establish a synchronization of) the image data and the millimeter-wave data. For example, data synchronizer 42 adjusts a timing at which the image data is generated and a timing at which the millimeter-wave data is generated, based on time information included in the image data and time information included in the millimeter-wave data.

For example, for image data of one frame, data synchronizer 42 selects such millimeter-wave data that a time difference between a time indicated by time information included in the image data and a time indicated by time information included in the millimeter-wave data is equal to or smaller than a predetermined value, and associates the selected millimeter-wave data with the image data of the one frame. Alternatively, for image data of one frame, data synchronizer 42 may select millimeter-wave data including time information indicating a time closest to a time indicated by time information included in the image data, and associate the selected millimeter-wave data with the image data of the one frame.

Note that, for example, in a case where the frequency at which camera 2 generates image data and a frequency at which millimeter-wave radar 3 generates millimeter-wave data are different, data synchronizer 42 may perform data synchronization so as to associate one image data with two different millimeter-wave data. Alternatively, data synchronizer 42 may perform data synchronization so as to associate one millimeter-wave data with two different image data. Data synchronizer 42 associates the image data and the millimeter-wave data with each other, in which the times indicated by each time information are included within a predetermined time.

Data synchronizer 42 outputs the synchronized data to data accumulator 43. Further, data synchronizer 42 outputs the synchronized data to determiner 44.

Data accumulator 43 accumulates the image data and the millimeter-wave data which have been synchronized by data synchronizer 42, in association with each other. Data accumulator 43 accumulates the image data and the millimeter-wave data in time series based on the time information, for example. Further, data accumulator 43 may accumulate image data and millimeter-wave data of each of the plurality of monitoring points.

Determiner 44 acquires the image data and the millimeter-wave data which have been synchronized (whose timings have been adjusted), from data synchronizer 42. Further, screen generator 45 may acquire instruction information including a setting related to intrusion detection and/or an instruction related to a monitoring point from remote monitoring PC 5 through communicator 41.

Determiner 44 determines whether or not there is a person intruding into an intrusion detection area included in the scanning area, based on the acquired millimeter-wave data. The processing in determiner 44 may also be described as intrusion detection processing.

The intrusion detection area may be set through the operator of remote monitoring PC 5 by a user performing monitoring, for example. In a case where the intrusion detection area is set by the user performing monitoring, remote monitoring PC 5 transmits instruction information including information indicating the intrusion detection area to information processing server 4. Alternatively, the intrusion detection area may be set in advance, for example, for a monitoring point.

For example, determiner 44 performs signal processing (for example, clustering processing) to millimeter-wave data of millimeter-wave radar 3 provided at a monitoring point, and estimates a region corresponding to a reflection object. Determiner 44 then determines whether or not the region corresponding to the reflection object is included in the intrusion detection area. Then, in a case where the estimated region is included in the intrusion detection area, determiner 44 estimates whether or not the reflection object corresponding to the estimated region is a person. In a case where the estimated region is included in the intrusion detection area and the reflection object corresponding to the estimated region is a person, determiner 44 determines that there is a person intruding into the intrusion detection area. Note that, determiner 44 may estimate a position of a person in the scanning area by estimating what a reflection object is for each region corresponding to the reflection object.

Here, determiner 44 not only determines the presence or absence of a person in the intrusion detection area as a determination result, but may also calculate reliability based on a positional relationship between the intrusion detection area and a reflection object (for example, a person), or the like, and output a determination result including the calculated reliability for each detection determination of the reflection object. For example, the reliability may be a value indicating a distance between the intrusion detection area and a reflection object, or a value based on a distance between the intrusion detection area and a reflection object and on a moving speed of the reflection object. The reliability may also be an index indicating a possibility of intrusion into the intrusion detection area.

Determiner 44 outputs the image data and the millimeter-wave data acquired from data synchronizer 42 to screen generator 45. Determiner 44 outputs information indicating a determination result to screen generator 45. Further, determiner 44 outputs the information indicating a determination result to data accumulator 43.

Determiner 44 may perform signal processing in accordance with a mode instructed by mode setter 46, and generate determination processing in accordance with the mode.

In a case where data accumulator 43 acquires the information indicating a determination result from determiner 44, data accumulator 43 accumulates the information indicating a determination result in association with the image data and the millimeter-wave data. Data accumulator 43 accumulates, for example, the image data, the millimeter-wave data, and the information indicating a determination result in time series. In this case, the information indicating a determination result corresponds to history information indicating a history of a person who has intruded into the intrusion detection area. Further, data accumulator 43 may also accumulate image data, millimeter-wave data, and information indicating a determination result of each of the plurality of monitoring points.

Screen generator 45 acquires the image data and the millimeter-wave data which have been synchronized (whose timings have been adjusted), from determiner 44. Screen generator 45 acquires the information indicating a determination result from determiner 44. Further, screen generator 45 may also acquire instruction information including a setting related to intrusion detection and/or an instruction related to a monitoring point from remote monitoring PC 5 through communicator 41.

Screen generator 45 then associates the image data and the millimeter-wave data which have been synchronized (whose timings have been adjusted), with each other, and generates a monitoring screen that indicates a determination result.

For example, screen generator 45 may perform coordinate conversion processing in which information of the millimeter-wave data defined by the millimeter-wave radar coordinate system is converted into that of the camera coordinate system. Screen generator 45 superimposes millimeter-wave data after the coordinate conversion on a camera image indicated by the image data.

Further, screen generator 45 superimposes the information indicating a determination result on the camera image indicated by the image data. For example, screen generator 45 superimposes a frame indicating a person intruding into the intrusion detection area on the camera image. Note that, in a case where regions corresponding to reflection objects (for example, a person) are included as an example of the millimeter-wave data information or as an example of the information indicating a determination result, screen generator 45 may also superimpose frames indicating regions corresponding to each reflection object on the camera image.

Note that, in a case where a determination result includes reliability, screen generator 45 may also superimpose information in accordance with the reliability on the camera image. For example, screen generator 45 may superimpose the information on the camera image by stepwise changing, corresponding to a value of the reliability, a display aspect of frames indicating positions of persons in a scanning area, which include a frame of a person intruding into the intrusion detection area. In this case, the monitoring screen indicates information indicating the person intruding into the intrusion detection area (for example, a frame indicating a position of the person) in accordance with reliability of persons around a periphery of the intrusion detection area.

Further, screen generator 45 may also superimpose information indicating a determination result on a zenith diagram of a monitoring point, and generate data of the zenith diagram including the determination result. In this case, screen generator 45 may also perform coordinate conversion processing in which millimeter-wave data information (the information indicating a determination result) defined by the millimeter-wave radar coordinate system is converted into that of a coordinate system defining the zenith diagram. Note that, the zenith diagram is a diagram obtained by imitating an area including a monitoring area when viewed from above. For example, the data of the zenith diagram is determined in advance for each monitoring point, and is accumulated in data accumulator 43.

Further, screen generator 45 performs signal processing in accordance with a mode instructed by mode setter 46 to generate a monitoring screen in accordance with the mode.

Screen generator 45 then transmits data of the generated monitoring screen to remote monitoring PC 5. Further, in a case where screen generator 45 generates data of a zenith diagram including a determination result, screen generator 45 may transmit the data of the zenith diagram to remote monitoring PC 5.

Mode setter 46 acquires instruction information through communicator 41. Mode setter 46 instructs a setting mode related to the monitoring screen, which is included in the instruction information, to determiner 44 and screen generator 45.

Note that, examples of the mode and the monitoring screen generated in accordance with the mode will be described later.

Note that, although an example of a configuration in which the intrusion detection system includes information processing server 4 that is a single body has been described above, the present disclosure is not limited thereto. For example, the intrusion detection system may also be configured to include a plurality of information processing servers that share and execute the processing to be performed by information processing server 4. In this case, for example, the processing to be performed by information processing server 4 may be shared by the plurality of information processing servers, and information (for example, millimeter-wave data, image data and/or determination result information) may be transferred between the plurality of information processing servers through a communication medium such as an internet protocol (IP) network and/or a local area network (LAN). For example, an information processing server dedicated to data accumulation corresponding to data accumulator 43 described above may be provided.

Further, the intrusion detection system may also include a cloud computer that performs at least part of the processing to be performed by information processing server 4. For example, a configuration may also be employed in which, among the processing to be performed by information processing server 4, processing involving a large calculation amount, for example, determination processing by determiner 44 is performed by a cloud computer capable of high-speed processing, and the remaining processing is performed by another information processing server.

<Processing Flow in Information Processing Server>

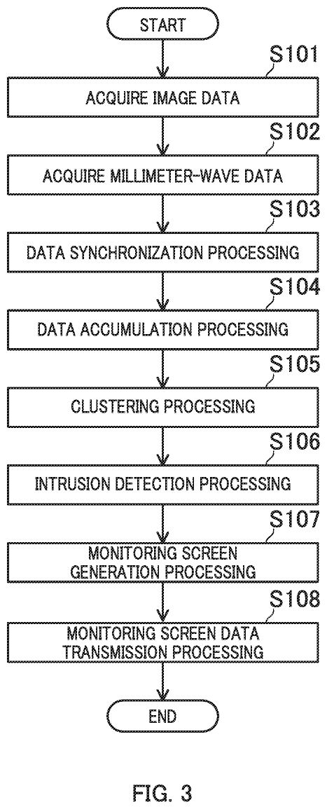

Next, an example of a processing flow to be executed in information processing server 4 will be described with reference to FIG. 3.

FIG. 3 is a flowchart illustrating an example of processing to be executed in information processing server 4 according to the present embodiment. Note that, the flowchart illustrated in FIG. 3 indicates processing to data acquired from camera 2 and millimeter-wave radar 3 provided at one monitoring point. Information processing server 4 may simultaneously perform the processing illustrated in FIG. 3 to data acquired from camera 2 and millimeter-wave radar 3 provided at each monitoring point.

Data synchronizer 42 acquires image data from camera 2 (S101).

Data synchronizer 42 acquires millimeter-wave data from millimeter-wave radar 3 (S102).

Note that, the order of S101 and S102 is not limited thereto. Further, the processing of S101 is executed each time camera 2 transmits image data, and the processing of S102 is executed each time millimeter-wave radar 3 transmits millimeter-wave data.

Data synchronizer 42 performs data synchronization processing in which the image data and the millimeter-wave data are synchronized (S103).

Data synchronizer 42 performs data accumulation processing in which the synchronized data are accumulated in data accumulator 43 (S104).

Determiner 44 performs clustering processing to the millimeter-wave data (S105).

The clustering processing is processing in which a plurality of reflection points included in millimeter-wave data and corresponding to one reflection object are grouped. Information on the reflection object, such as the size, shape, and color of the reflection object, may also be acquired by the grouping processing. Note that, a region including a group of a plurality of reflection points corresponding to one reflection object after the clustering processing will be described hereinafter as a reflection region.

Note that, in the clustering processing, determiner 44 may also use millimeter-wave data before current millimeter-wave data, which is accumulated in data accumulator 43. By using the millimeter-wave data before the current millimeter-wave data and processing the millimeter-wave data in time series, determiner 44 may, for example, distinguish between a reflection point corresponding to a moving body and a reflection point corresponding to a stationary object.

Next, determiner 44 performs intrusion detection processing (S106).

Note that, determiner 44 may also receive an instruction from mode setter 46 and perform processing in accordance with a mode.

Next, screen generator 45 performs processing of generating a monitoring screen of intrusion detection (S107). Screen generator 45 then associates the image data and the millimeter-wave data with each other, and generates data of the monitoring screen that indicates a determination result by determiner 44.

For example, screen generator 45 performs processing of superimposing the millimeter-wave data on a camera image indicated by the image data. In this processing, screen generator 45 may perform coordinate conversion of information indicating a determination result such that the camera coordinate system and the millimeter-wave radar coordinate system are aligned. Screen generator 45 then superimposes, for example, information whereby a person intruding into an intrusion detection area is specified (for example, a frame surrounding the intruding person) as an example of the information indicating a determination result.

Screen generator 45 performs processing of transmitting the generated data of the monitoring screen (S108).

Next, an example of modes to be set in the present embodiment and an example of screens to be displayed based on the modes will be described.

<Setting Mode>

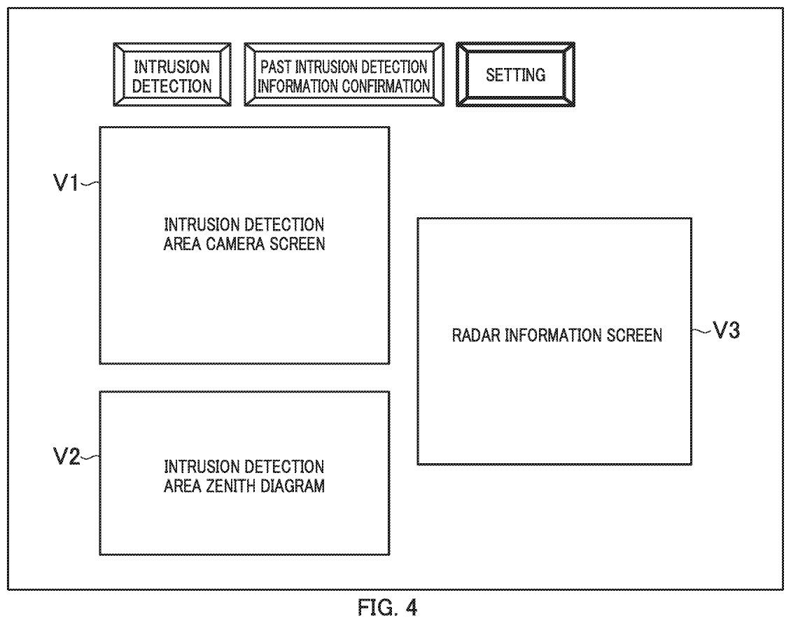

The setting mode is a mode in which the user performing monitoring performs a setting. FIG. 4 illustrates an example of a display screen in a setting mode in the present embodiment.

In an upper portion of FIG. 4, an “intrusion detection” button, a “past intrusion detection information confirmation” button, and a “setting” button are illustrated. FIG. 4 is a screen displayed on the display of remote monitoring PC 5 in the setting mode, and is therefore displayed in a state where the setting button is depressed. FIG. 4 illustrates three regions of region V1 of “intrusion detection area camera screen”, region V2 of “intrusion detection area zenith diagram”, and region V3 of “radar information screen”.

Region V1 of “intrusion detection area camera screen” indicates a region in which a camera image is displayed. Remote monitoring PC 5 displays the camera image in region V1 of “intrusion detection area camera screen” based on image data.

Region V2 of “intrusion detection area zenith diagram” indicates a region in which a zenith diagram generated by information processing server 4 is displayed. Remote monitoring PC 5 displays the zenith diagram in region V2 of “intrusion detection area zenith diagram” based on data of the zenith diagram. A user sets an intrusion detection area to the zenith diagram through the operator of remote monitoring PC 5. For example, a user selects an area that is a part of the zenith diagram by mouse operation, and sets the selected area as the intrusion detection area.

Note that, a user may set an area (intrusion detection area filter) in which no intrusion detection is performed. Information on the set intrusion detection area (or intrusion detection area filter) is included in instruction information, and is transmitted to information processing server 4.

Region V3 of “radar information screen” indicates a region in which millimeter wave data acquired from information processing server 4 is displayed. In region V3 of “radar information screen”, remote monitoring PC 5 displays, based on the millimeter-wave data and by using a position of millimeter-wave radar 3 as a reference, a screen on which reflection points are scattered in a fan-shaped coordinate system defined based on a distance from millimeter-wave radar 3 and an azimuth direction in which millimeter-wave radar 3 scans.

In a case where information processing server 4 acquires instruction information indicating the “setting mode” from remote monitoring PC 5, information processing server 4 transmits the image data and the millimeter-wave data which have been synchronized, to remote monitoring PC 5. Further, information processing server 4 transmits data of a zenith diagram held in data accumulator 43 in advance to remote monitoring PC 5. Remote monitoring PC 5 performs display in each region of the display based on the received data.

Information on the intrusion detection area set by a user is included in instruction information, and is transmitted to information processing server 4. Based on the information on the intrusion detection area, determiner 44 of information processing server 4 sets an intrusion detection area in the millimeter-wave radar coordinate system. In this case, determiner 44 may perform coordinate conversion in which the intrusion detection area in the zenith diagram is converted into an intrusion detection area in the millimeter-wave radar coordinate system. The correspondence relationship between the coordinate system defining the zenith diagram and the millimeter-wave radar coordinate system is known. Determiner 44 may convert the intrusion detection area in the zenith diagram into an intrusion detection area in the millimeter-wave radar coordinate system based on the known correspondence relationship.

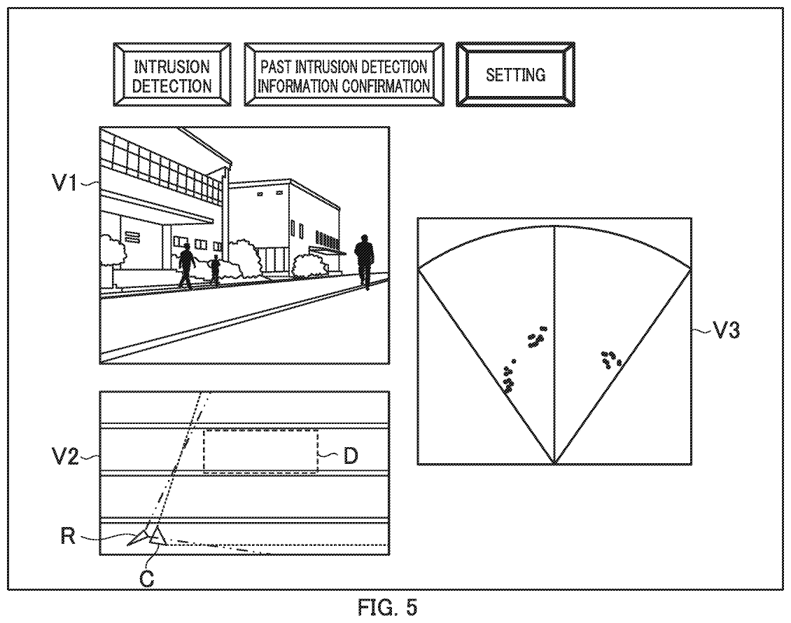

FIG. 5 illustrates an example of screens displayed in each region illustrated in FIG. 4.

Region V1 displays a camera image. Region V2 displays a zenith diagram. Region V3 displays radar information.

In the zenith diagram of region V2, “C” represents the position of camera 2, and “R” represents the position of millimeter-wave radar 3. Further, the zenith diagram of region V2 illustrates an auxiliary line indicating the monitoring area of camera 2 and an auxiliary line indicating the scanning area of millimeter-wave radar 3. A user refers to the auxiliary lines, and sets intrusion detection area D in an area included in both the monitoring area and the scanning area.

<Intrusion Detection Mode>

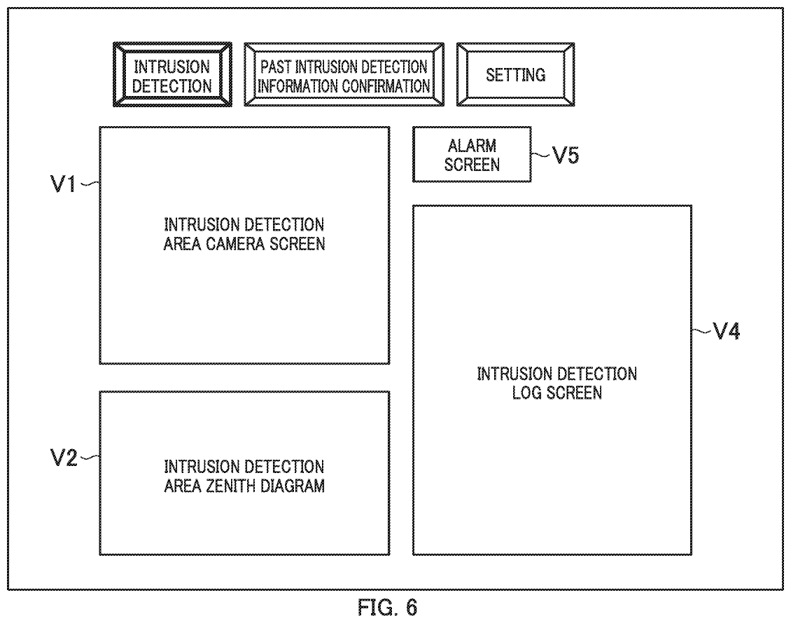

The intrusion detection mode is a mode in which a person intruding into the intrusion detection area set by the setting mode is detected. FIG. 6 illustrates an example of a display screen in an intrusion detection mode in the present embodiment.

In an upper portion of FIG. 6, the “intrusion detection” button, the “past intrusion detection information confirmation” button, and the “setting” button are illustrated. FIG. 6 is a screen displayed on the display of remote monitoring PC 5 in the intrusion detection mode, and is therefore displayed in a state where the intrusion detection button is depressed. FIG. 6 indicates four regions of region V1 of “intrusion detection area camera screen”, region V2 of “intrusion detection area zenith diagram”, region V4 of “intrusion detection log screen”, and region V5 of “alarm screen”.

Region V1 of “intrusion detection area camera screen” indicates a region in which a monitoring screen generated by information processing server 4 is displayed. Remote monitoring PC 5 displays the monitoring screen in region V1 of “intrusion detection area camera screen” based on data of the monitoring screen. On the monitoring screen, a determination result of intrusion detection processing based on millimeter-wave data is superimposed on a camera image.

Region V2 of “intrusion detection area zenith diagram” indicates a region in which a zenith diagram generated by information processing server 4 and including the determination result of the intrusion detection processing is displayed. Remote monitoring PC 5 displays the zenith diagram in region V2 of “intrusion detection area zenith diagram” based on data of the zenith diagram including the determination result of the intrusion detection processing.

Region V4 of “intrusion detection log screen” indicates a region in which intruder log information generated by information processing server 4 and acquirable by the intrusion detection processing is displayed.

Region V5 of “alarm screen” indicates a region in which an alarm is displayed in a case where there is an intruder, based on the determination result of the intrusion detection processing.

In a case where information processing server 4 acquires instruction information indicating the “intrusion detection mode” from remote monitoring PC 5, determiner 44 executes intrusion detection processing to the set intrusion detection area. Screen generator 45 then transmits data of a monitoring screen in which information indicating a determination result of the intrusion detection processing is superimposed on a camera image, and data of a zenith diagram including the information indicating the determination result of the intrusion detection processing. Further, screen generator 45 generates intruder log information based on the monitoring screen, and transmits the log information to remote monitoring PC 5. Remote monitoring PC 5 performs display in each region of the display based on the received data.

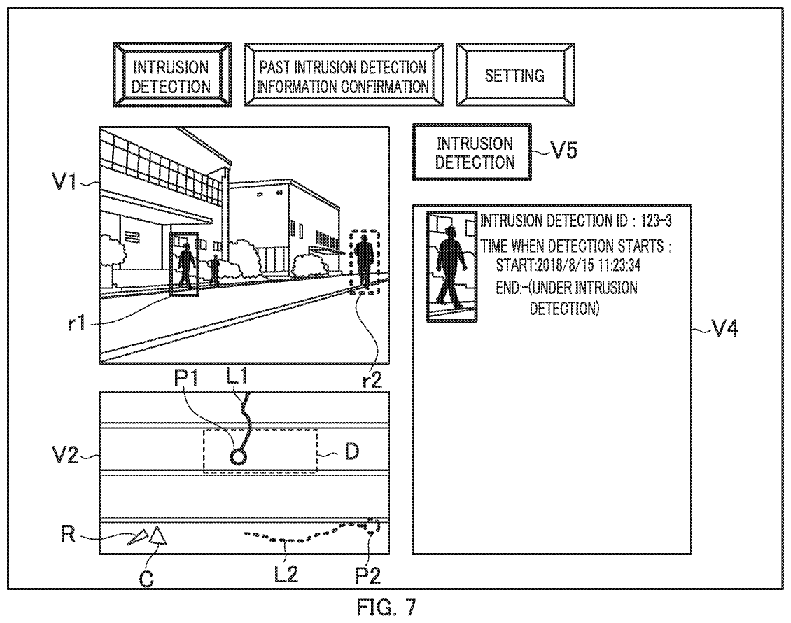

FIG. 7 illustrates an example of screens displayed in each region illustrated in FIG. 6.

Region V1 displays a monitoring screen generated by information processing server 4. Note that, region V1 indicates frame r1 indicating a position of an intruder, and frame r2 indicating a position of a non-intruder (a person not intruding into an intrusion detection area). Frames r1 and r2 are indicated with, for example, different display aspects (for example, different colors).

Note that, in a case where a determination result includes reliability, frame r1 indicating a position of an intruder, and frame r2 indicating a position of a non-intruder may be displayed in display aspects corresponding to the reliability. For example, in a case where a person outside an intrusion detection area gradually approaches the intrusion detection area and moves into the intrusion detection area, a frame display is changed by using a gradation effect such that a frame color gradually changes from white to red in accordance with the reliability based on a distance between the intrusion detection area and the person. Further, the frame display may also be changed by using a plurality of colors in the order of green, yellow, and red, for example. Further, at least one of the thickness, type, color tone, brightness, and contrast of a frame line may be changed in accordance with the reliability. Alternatively, a frame may be blinked, and an interval (time) of blinking may be changed in accordance with the reliability.

Displaying frames in display aspects corresponding to the reliability makes it possible to visually indicate whether or not an intrusion into an intrusion detection area is highly likely.

Here, an example of a method for determining frame r1, which indicates an position of an intruder to be detected by using millimeter-wave data and is displayed on a camera image, will be described. Frame r1 is determined in a case where intrusion detection processing is executed in determiner 44.

Determiner 44 uses millimeter-wave data, and estimates a reflection point corresponding to an intruder. The reflection point is a point in a two-dimensional coordinate system, which defines the millimeter-wave data.

Next, screen generator 45 calculates a point (hereinafter, referred to as a camera image reflection point) corresponding to the reflection point in the camera coordinate system. For example, screen generator 45 calculates the camera image reflection point by using camera installation position information of camera 2.

The camera installation position information includes a two-dimensional coordinate indicating an installation position of camera 2, and an installation direction of camera 2 in the millimeter-wave radar coordinate system. The installation direction corresponds to a central direction of a camera image captured by camera 2.

Next, screen generator 45 calculates a distance between the reflection point and the camera installation position, and calculates a direction of the reflection point with respect to the installation direction of the camera.

For example, in a case where camera 2 is installed horizontally with respect to a road surface, the X coordinate (horizontal position) of the camera image reflection point is determined based on the direction of the reflection point with respect to the installation direction of camera 2, and information on a predetermined viewing angle of camera 2. Further, the Y coordinate (vertical direction) of the camera image reflection point is set at a center in a vertical direction of the camera image.

For example, in a case where camera 2 is installed, not horizontally with respect to the road surface, but with a depression angle, the X coordinate and the Y coordinate of the camera image reflection point are calculated based on the direction of the reflection point with respect to the installation direction of camera 2, a height of the installation position of camera 2, the depression angle of camera 2, and the viewing angle of camera 2.

Screen generator 45 determines a rectangular frame by using the camera image reflection point as a reference. For example, a width and a height of a rectangle are set, based on a distance between the camera image reflection point and the camera installation position, and by preliminarily enlarging or reducing a width and a height each of which serves as a reference. For example, the width and the height of the rectangle are set, in inverse proportion to the distance between the camera image reflection point and the camera installation position, and by enlarging or reducing the width and the height of the rectangle, each of which serves as a reference.

Screen generator 45 superimposes a rectangular frame having a set width and a set height around the camera image reflection point, and generates a monitoring screen.

Region V2 displays a zenith diagram. The zenith diagram of region V2 indicates point P1 indicating a position of an intruder corresponding to the intruder indicated by frame r1 of region V1, and track L1 of movement of the former intruder. Further, the zenith diagram of region V2 indicates point P2 indicating a position of a non-intruder indicated by frame r2 of region V1, and track L2 of movement of the non-intruder. Positions P1 and P2 are indicated with, for example, different display aspects (for example, different colors). Tracks L1 and L2 are indicates with, for example, different display aspects (for example, different colors).

Note that, regions V1 and V2 may not display information on a non-intruder (frame r2, point P2, and track L2).

Region V4 displays intruder log information. The intruder log information includes, for example, an image indicating an intruder, which is cut off from frame r1 of region V1. Further, the intruder log information includes a time when the intruder starts an intrusion into an intrusion detection area, and a time when the intruder leaves the intrusion detection area. Further, an identification (ID) is attached to the intruder after the intrusion is detected.

Region V5 displays character information (alarm information) indicating that an intruder has been detected. Monitoring personnel who see the alarm information can grasp that there is an intruder. Note that, the display of the alarm information may also be linked with another notification apparatus (for example, a lamp and/or a buzzer), and further may be linked with an external warning system and/or an external monitoring system. For example, distributing the alarm information to a monitoring system of a warning district in its entirety makes it possible to notify an outside monitoring person as well.

<Past Intrusion Detection Information Confirmation Mode>

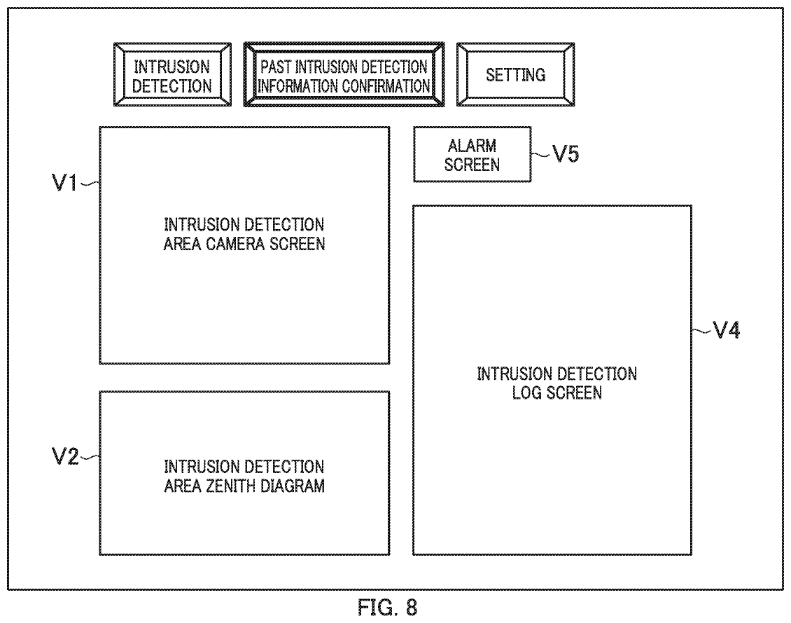

The past intrusion detection information confirmation mode is a mode in which information on previously detected intruders is confirmed. FIG. 8 illustrates an example of a display screen in a past intrusion detection information confirmation mode in the present embodiment.

In an upper portion of FIG. 8, the “intrusion detection” button, the “past intrusion detection information confirmation” button, and the “setting” button are illustrated. FIG. 8 is a screen displayed on the display of remote monitoring PC 5 in the past intrusion detection information confirmation mode, and is therefore displayed in a state where the past intrusion detection information confirmation button is depressed. FIG. 8 illustrates four regions of region V1 of “intrusion detection area camera screen”, region V2 of “intrusion detection area zenith diagram”, region V4 of “intrusion detection log screen”, and region V5 of “alarm screen”.

Note that, since the example of the display screen of FIG. 8 is the same as the example of the display screen illustrated in FIG. 6 except that the past intrusion detection information confirmation button is depressed, a detailed description thereof will be omitted.

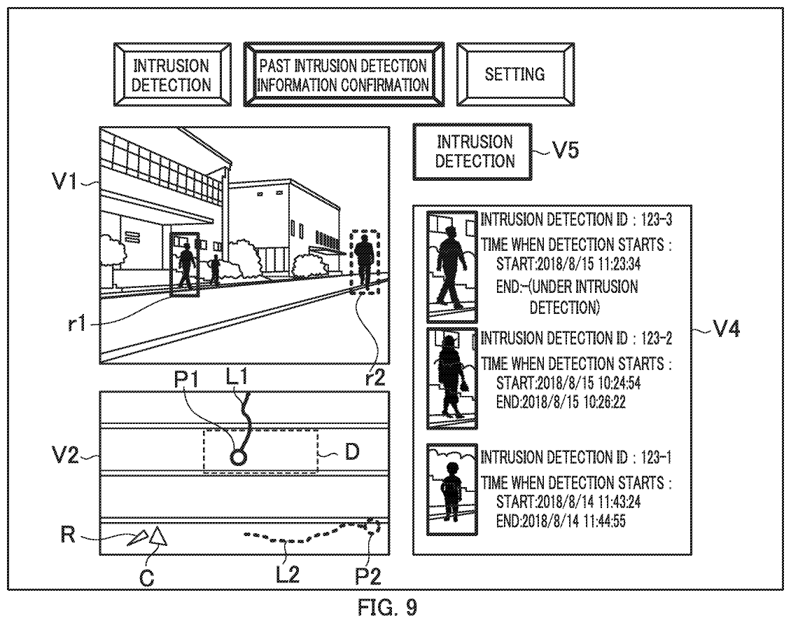

The past intrusion detection information confirmation mode differs in information displayed in region V4 of intrusion detection log screen from the intrusion detection mode described in FIGS. 6 and 7. Hereinafter, this point will be described with reference to FIG. 9.

FIG. 9 illustrates an example of screens displayed in each region illustrated in FIG. 8.

Since the display examples of regions V1, V2 and V5 are the same as those in FIG. 7, a detailed description thereof will be omitted.

Region V4 displays intruder log information. The intruder log information includes, for example, an image indicating an intruder, which is cut off from frame r1 of region V1. Further, the intruder log information includes a time when the intruder starts an intrusion into an intrusion detection area and a time when the intruder left the intrusion detection area. Further, an identification (ID) is attached to the intruder after the intrusion is detected.

Further, in the past intrusion detection information confirmation mode, region V4 displays information on intruders who have previously intruded into an intrusion detection area.

Region V4 of FIG. 9 displays log information on two intruders in addition to log information on an intruder currently intruding into an intrusion detection area, that is, the intruder indicated by frame r1 of region V1. The IDs “123-2” and “123-1” are attached to the two intruders, respectively. The two intruders are intruders who have been previously detected as indicated by the detection times.

Note that, information on an intruder may be called by a user's operation (for example, clicking) of the display of region V4. For example, by selecting (clicking) an intruder displayed in region V4, a camera image during the intrusion of the selected intruder into an intrusion detection area may be displayed in region V1 or another region.

Further, a setting for an intruder may be changed by a user's operation (for example, clicking) of the display of region V4. For example, by selecting (clicking) an intruder displayed in region V4, setting (filter registration) to permit the selected intruder to intrude into an intrusion detection area may be performed. For an intruder permitted to intrude into an intrusion detection area, even when an intrusion of the intruder into the intrusion detection area is detected afterward, information indicating the detection is not displayed.

Note that the above-described operation method is merely an example, and the present disclosure is not limited thereto. For example, a menu may be displayed by selecting (clicking) an intruder displayed in region V4. A user may perform setting to permit display of a camera image and an intrusion in the displayed menu.

As described above, information processing server 4 according to the present embodiment synchronizes (adjusts timings of) image data captured by a camera and millimeter-wave data acquired by a millimeter-wave radar, and performs intrusion detection processing in which it is detected based on the millimeter-wave data that there is an intruding object. Further, information processing server 4 according to the present embodiment associates the image data and the millimeter-wave data which have been synchronized (whose timings have been adjusted), with each other, and generates a monitoring screen that indicates a determination result of the intrusion detection processing. According to the present embodiment, two sensor devices, that is, a camera and a radar, are combined, and an intrusion can be accurately detected.

For example, a camera image acquirable from data of a camera can provide a user performing monitoring with visually effective information, and data of a millimeter-wave radar can provide the user performing monitoring with detailed information that cannot be acquired from the camera image. Accordingly, the present embodiment makes it possible to accurately detect an intrusion by associating a result of intrusion detection acquirable from a millimeter-wave radar with a camera image.

Various embodiments have been described above with reference to the drawings. However, it goes without saying that the present disclosure is not limited to these embodiments. It is obvious that one of ordinary skill in the art can conceive various modified examples and correction examples within the scope recited in the claims. It should be naturally understood that these modified examples and correction examples belong to the technical scope of the present disclosure. Furthermore, each component of the above embodiments may be optionally combined without departing from the gist of the disclosure.

The notation “ . . . section” or “-er, -or, and -ar” used in the description of each embodiment described above may be replaced with other notations such as “ . . . circuitry”, “ . . . device”, “ . . . unit” and “ . . . module”.

The present disclosure can be realized by software, hardware, or software in cooperation with hardware.

Each functional block used in the description of the each embodiment described above can be partly or entirely realized by an LSI such as an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It should be noted that the present disclosure can be represented as a control method performed in a radio communication apparatus or a control apparatus. Further, the present disclosure can also be represented as a program for causing the control method to be operated with a computer. In addition, the present disclosure can be also represented as a recording medium where the program is recorded so as to be readable by a computer. That is, the present disclosure may be represented in any category of devices, methods, programs, and recording media.

It should also be noted that the present disclosure is not limited to the each embodiment described above in terms of e.g. the type, arrangement, number of members, and alterations can be made as appropriate without departing from the scope of the present invention by, for example, appropriately substituting the components with those having equivalent operational effects.

The disclosure of Japanese Patent Application No. 2018-070954, filed on Apr. 2, 2018, including the specification, drawings and abstract, is incorporated herein by reference in its entirety.

### INDUSTRIAL APPLICABILITY

The exemplary embodiment of the present disclosure is suitable for detecting an intrusion into a specific area.

### REFERENCE SIGNS LIST

1 Intrusion detection system

2 Camera

3 Millimeter-wave radar

4 Information processing server (control apparatus)

5 Remote monitoring PC

41 Communicator

42 Data synchronizer

43 Data accumulator

44 Determiner

45 Screen generator

46 Mode setter

1. An intrusion detection system, comprising:
a camera that captures a monitoring area, and generates image data;
a millimeter-wave radar that scans a scanning area included in the monitoring area, and generates millimeter-wave data; and
an information processing server that is connected to the camera and the millimeter-wave radar, and acquires the image data and the millimeter-wave data, wherein
the information processing server includes:
a data synchronizer that synchronizes the image data and the millimeter-wave data such that a difference between a timing at which the image data is generated and a timing at which the millimeter-wave data is generated is equal to or smaller than a certain value;
a determiner that determines based on the millimeter-wave data whether or not there is an object intruding into a detection area included in the scanning area; and
a screen generator that associates the image data and the millimeter-wave data which have been synchronized, with each other, and generates a monitoring screen that indicates a determination result by the determiner.

2. The intrusion detection system according to claim 1, comprising a data accumulator that accumulates the image data and the millimeter-wave data which have been synchronized by the data synchronizer, wherein
the determiner determines whether or not there is the object intruding into the detection area by using the millimeter-wave data accumulated in the data accumulator, and
the screen generator generates the monitoring screen by using the image data and the millimeter-wave data accumulated in the data accumulator.

3. The intrusion detection system according to claim 2, wherein:
the data accumulator accumulates history information indicating a history of an object that has previously intruded into the detection area.

4. The intrusion detection system according to claim 3, wherein:
the screen generator generates log information in which the object intruding into the detection area is displayed in time series, based on the history information.

5. The intrusion detection system according to claim 1, wherein:
the screen generator generates, in a diagram of an area including the monitoring area when viewed from above, a zenith diagram that indicates information indicating the determination result.

6. The intrusion detection system according to claim 1, wherein:
the monitoring screen displays information indicating the object intruding into the detection area and information indicating an object not intruding into the detection area with different display aspects.

7. The intrusion detection system according to claim 1, wherein:
the monitoring screen indicates information indicating an object that has intruded into the detection area, in accordance with reliability of the object intruding into the detection area.

8. The intrusion detection system according to claim 1, wherein:
alarm information is displayed on the monitoring screen in a case where there is the object intruding into the detection area.

9. The intrusion detection system according to claim 1, wherein:
the screen generator converts the millimeter-wave data corresponding to the scanning area such that the millimeter-wave data corresponds to the monitoring area.

10. An intrusion detection method, comprising:
acquiring image data from a camera, the image data being generated by capturing a monitoring area;
acquiring millimeter-wave data from a millimeter-wave radar, the millimeter-wave data being generated by scanning a scanning area included in the monitoring area;
synchronizing the image data and the millimeter-wave data such that a difference between a timing at which the image data is generated and a timing at which the millimeter-wave data is generated is equal to or smaller than a certain value;
determining based on the millimeter-wave data whether or not there is an object intruding into a detection area included in the scanning area; and
associating the image data and the millimeter-wave data which have been synchronized, with each other, and generating a monitoring screen that indicates a determination result.
